(19) United States
(12) Patent Application Publication
(10) Pub. No.: US 2005/0281600 A1
(43) Pub. Date: Dec. 22, 2005

(54) Sheet processing apparatus

(75) Inventors: Masao Akaiwa, Shiojiri-shi (JP); Yoichi Hine, Kashiwa-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/135,852

(22) Filed: May 23, 2005

(30) Foreign Application Priority Data
Jun. 17, 2004 (JP) 2004-179689

(51) Int. Cl. B41J 3/32

(52) U.S. Cl. 400/109.1

(57) ABSTRACT

An apparatus for processing a sheet is made up of an embossing unit for embossing a Braille character string on the sheet in accordance with inputted information while feeding the sheet, a Braille embossing area setting unit for arbitrarily setting the position of the Braille embossing area in which to emboss the Braille character string on the sheet, and a control unit for controlling the embossing unit in accordance with a result of the setting made by the Braille embossing area setting unit.

### BACKGROUND OF THE INVENTION

1. Field of the Invention

This invention relates to a sheet processing apparatus capable of performing ink-printing (i.e., printing of written characters with ink) and Braille embossing (i.e., embossing of raised characters) on a sheet.

2. Description of the Related Art

There is known a tape printing/embossing apparatus (sheet processing apparatus) which performs ink-printing in a flat character printing area of a tape (sheet) using ink-printing means and performs Braille-embossing in a Braille embossing area using embossing means while feeding the tape (sheet).

Braille characters are touched with a finger by visually impaired persons to recognize them. Therefore, it is desirable that when Braille characters are embossed on a sheet, a Braille embossing area be specified on the sheet such that visually impaired persons can easily touch the embossed Braille characters. However, the conventional tape printing/embossing apparatus is incapable of specifying the Braille embossing area on a sheet, and thus resultant Braille characters embossed on the sheet are not always in a form desirable for visually impaired persons.

### SUMMARY OF THE INVENTION

In view of the above, this invention has an advantage of providing a sheet processing apparatus capable of specifying a Braille embossing area on a sheet.

According to this invention, there is provided a sheet processing apparatus comprising: embossing means for embossing a Braille character on a sheet according to inputted information while feeding the sheet; Braille embossing area setting means for arbitrarily setting a position of a Braille embossing area in which to emboss the Braille character on the sheet; and control means for controlling the embossing means in accordance with a result of the setting made by the Braille embossing area setting means.

According to this arrangement, by properly setting the Braille embossing area on the sheet using the Braille embossing area setting means, it is possible to emboss the Braille character at a desirable position on the sheet. More specifically, a user can set a Braille embossing area on a sheet such that the Braille character is embossed in a form that allows visually impaired persons to easily touch the Braille character, depending on the size the of sheet, the purpose of the sheet (on which the Braille character is embossed), a place where the sheet is used, the content represented by the Braille character, etc. Note that the Braille embossing area refers to an area from a point at which embossing of the Braille character starts to a point at which embossing of Braille character ends. If the position of a Braille embossing area is set using the Braille embossing area setting means, the Braille embossing start position and the Braille embossing end position are defined, and thus positions of all Braille characters to be embossed on a sheet are defined.

Preferably, the Braille embossing area setting means sets the position of the Braille embossing area by selecting an arbitrary one of predefined options in terms of the relative position of the Braille embossing area on the sheet.

By using the Braille embossing area setting means capable of setting the position of the Braille embossing area by selecting an arbitrary one of predefined options in terms of the relative position of the Braille embossing area on the sheet, the user can quickly and easily set the Braille embossing area. This allows an improvement in the ease of operation performed by the user.

Preferably, the predefined options comprise: left justification in which the leading end of the Braille embossing area is aligned with the leading end of the sheet in a direction in which the sheet is fed; center justification in which the center of the Braille embossing area is aligned with the center of the sheet in the direction in which the sheet is fed; and right justification in which the trailing end of the Braille embossing area is aligned with the trailing end of the sheet in the direction in which the sheet is fed.

This makes it possible to easily set the Braille embossing area in one of formats of left justification, center justification and right justification. These three formats are most frequently used in setting of the position of the Braille embossing area, and thus the provision of these three formats as options allows a great improvement in ease of operation performed by users.

Preferably, the predefined options comprise one positioning in which the Braille is embossed in substantially widthwise one half of the sheet and another positioning in which the Braille is embossed in substantially the other widthwise half of the sheet.

By selecting one of these options in terms of the position of the Braille embossing area in substantially widthwise one half of the sheet and another positioning in which the Braille is embossed in substantially the other widthwise half of the sheet, it is possible to easily set the Braille embossing area at either half of the sheet as seen in the widthwise direction of the sheet (i.e., in the direction perpendicular to the direction of feeding the sheet).

Preferably, the sheet processing apparatus further comprises: ink-printing means for ink-printing the character on the sheet in accordance with the inputted information while feeding the sheet; and ink-printing area setting means for arbitrarily setting the position of an ink-printing area in which to ink-print the character on the sheet. The control means controls the ink-printing means in accordance with a result of the setting made by the ink-printing area setting means.

According to this arrangement, the ink-printing area setting means allows to arbitrarily set the position of the ink-printing area in which to ink-print the character on the sheet. When ink-printing and Braille embossing are performed on the same sheet, it is possible to perform ink-printing taking into account the position of the Braille embossing area. For example, if the Braille character is embossed in an area overlapping an area in which ink-printed characters are formed, the ink-printed character can become difficult to read. This problem can be avoided by setting the Braille embossing area and the ink-printing area such that they do not overlap each other. This makes it possible to provide great convenience to vision-impaired persons and sighted person.

### BRIEF DESCRIPTION OF THE DRAWINGS

FIG. 1 is a perspective view showing the appearance of a label producing apparatus according to an embodiment of this invention, the label producing apparatus being in a state in which an opening-and-closing cover is closed;

FIG. 2 is a perspective view showing the appearance of the label producing apparatus according to the embodiment of this invention, the label producing apparatus being in a state in which the opening-and-closing cover is open;

FIG. 3A is a plan view of an embossing unit and associated parts in a Braille embossing apparatus, and FIG. 3B is a front view thereof;

FIGS. 4A to 4C are schematic diagrams illustrating a manner in which unit moving means moves depending on a specified position of a Braille embossing area;

FIG. 5 is a schematic block diagram of a control system of a label producing apparatus according to an embodiment of the invention;

FIG. 6 illustrates a change, during a process of producing a label, in a setting item selection screen displayed on a display of a label producing apparatus;

FIG. 7 illustrates an example of a change in a screen when a setting item “operation mode” is selected;

FIG. 8 illustrates an example of a change in a screen when a setting item “form” is selected;

FIG. 9A illustrates a table indicating options allowed for each width of a tape, and FIG. 9B illustrates examples of labels produced when “ink-printing and Braille (overlapping)”, “ink-printing (upper) and Braille (lower)”, and “Braille (upper) and ink-printing (lower)” are selected respectively;

FIG. 10A illustrates a change in a screen when layout setting is performed in a state in which “Braille and ink-printing (overlapping)”, “ink-printing (upper) and Braille (lower)” or “Braille (upper) and ink-printing (lower)” has already been selected, and FIG. 10B illustrates an example of a label produced when “Braille (upper) and ink-printing (lower)”, “left justification” for a Braille character string, and “right justification” for an ink-printing character string are selected;

FIG. 11A illustrates a change in a screen when “free form” is selected in a layout setting menu and further “select from menu” is selected, and FIG. 11B illustrates options allowed for each width of a tape;

FIG. 12 is a diagram showing a manner in which layouts of an ink-printing character string and a Braille character string are set when “free form” is selected in a layout setting menu;

FIG. 13A is a table illustrating setting options (part of all available options) in terms of character decoration, and FIG. 13B illustrates an example of a label on which decorate characters are formed; and

FIG. 14A is a perspective view of a label producing apparatus according to an embodiment of this invention, and FIG. 14B is a plan view thereof.

### DETAILED DESCRIPTION OF THE PREFERRED EMBODIMENTS

Referring to the accompanying drawings, a label producing apparatus, which is an embodiment of a sheet (or tape) processing apparatus according to this invention, is descried below. The label producing apparatus is capable of performing both ink-printing and Braille embossing on a tape (sheet) to produce a Braille label recognizable by sighted persons and vision-impaired persons.

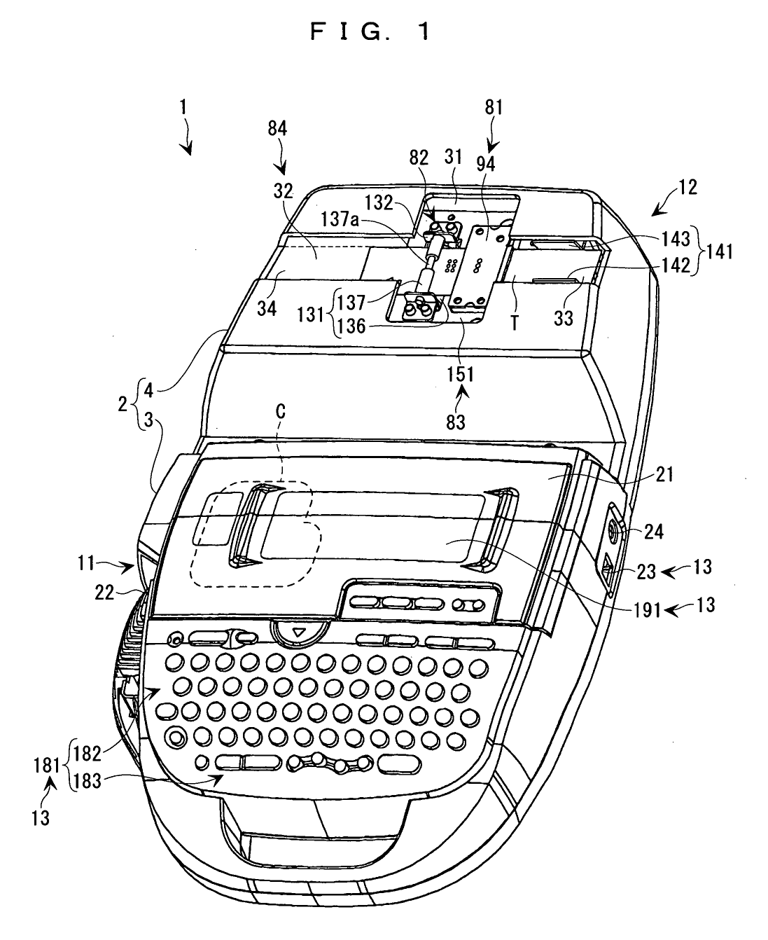

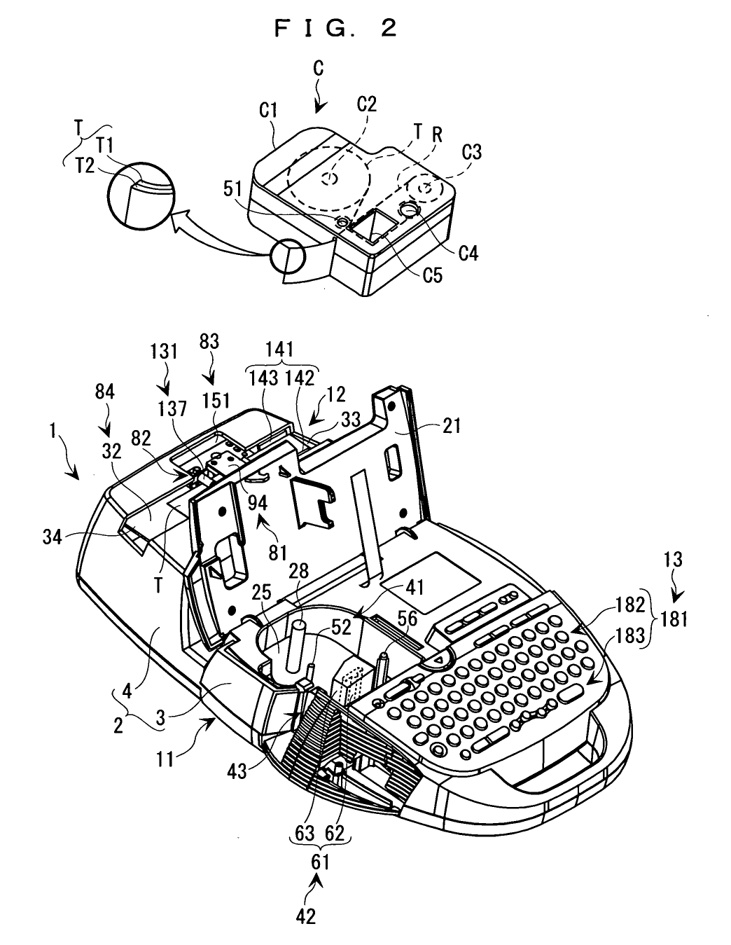

FIG. 1 is a perspective view showing the appearances of a label producing apparatus in a state in which an opening-and-closing cover is closed, and FIG. 2 is a perspective view showing the appearance of the label producing apparatus in a state in which the opening-and-closing cover is open. As shown in FIGS. 1 and 2, the contour of the label producing apparatus 1 is defined by the contour of an apparatus case 2 composed of a front case 3 and a rear case 4 located at the rear of the front case 3. The front case 3 and the rear case 4 are combined together in a single piece.

In the front case 3, there is disposed an ink-printing apparatus 11 (that will be described later). A keyboard 181 having various keys is disposed in a front area of the upper surface of the front case 3. The opening-and-closing cover 21 having a display unit 191 is disposed in a rear area of the upper surface of the front case 3. The left-hand side face of the front case 3 has a tape ejection port 22. Connectors 23 and 24 for connection with an external apparatus or a commercial power source are disposed on the right-hand side face of the front case 3.

The front case 3 has a cartridge mounting concave 25 which is formed behind the opening-and-closing cover 21 such that a tape cartridge C in which a tape T is disposed can be removably mounted in the cartridge mounting concave 25. Although not illustrated in FIGS. 1 and 2, a tape feeding path along which to feed the tape T from the cartridge mounting concave 25 to the tape ejection port 22 is also formed.

As shown in FIG. 2, the tape cartridge C includes: a cartridge case C1 that entirely covers the tape cartridge C; a tape reel C2 around which the long tape T is wound in a roll form; a ribbon feed reel C3 around which a long ink ribbon R is wound in the form of a roll; and a ribbon take-up reel C4 for taking up the ink ribbon R fed from the ribbon feed reel C3. The cartridge case C1 has a through hole (or penetrating hole) C5 in which a head unit (described later) is loosely inserted, and also has a platen roller 51 disposed at a location facing the through hole C5. The tape T is fed out of the cartridge case C1 through the through hole C5. The ink ribbon is brought into contact with the tape T at the location facing the through hole C5, and is then transported around the through hole C5.

In the cartridge mounting concave 25, a cartridge positioning shaft 28 projects from the bottom in a vertical direction so that the tape cartridge C is positioned by the cartridge positioning shaft 28 when the tape cartridge C is mounted in the cartridge mounting concave 25. In the cartridge mounting concave 25, a platen driving shaft 52 engaging with the platen roller 51 and a ribbon take-up shaft 56 engaging with the ribbon take-up reel C4 are disposed such that they project vertically from the bottom of the cartridge mounting concave 25 in a freely rotatable manner. Furthermore, in the cartridge mounting concave 25, a head unit 61 is vertically disposed so as to face the platen driving shaft 52.

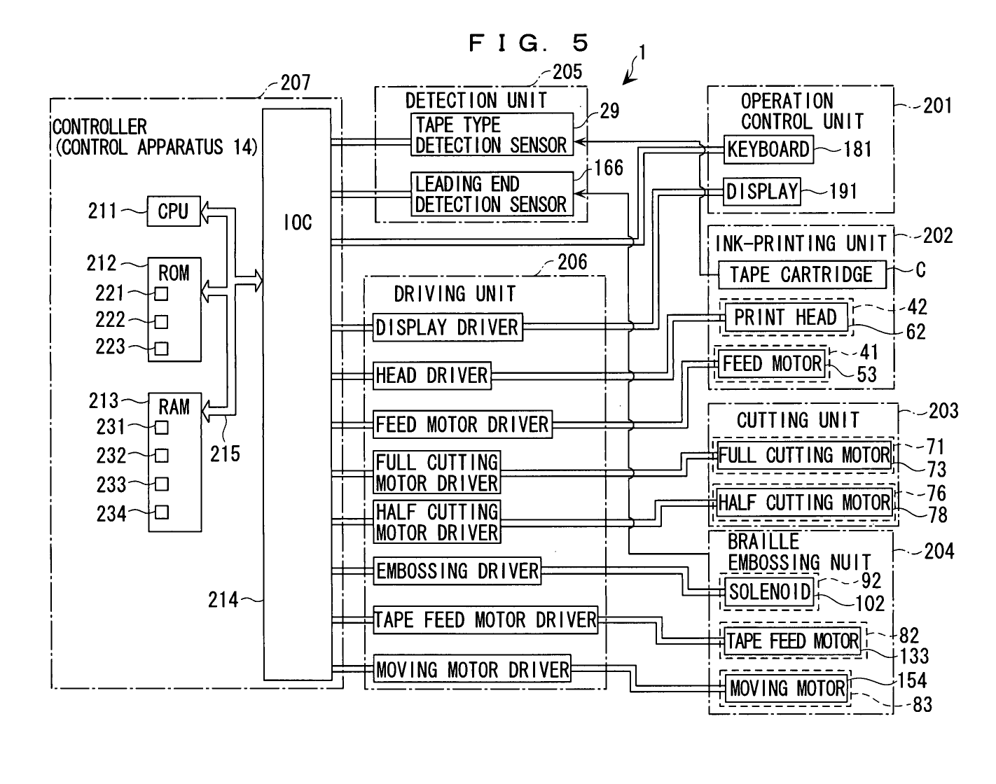

The tape T is formed in a multilayer structure including a base sheet T1 whose back side is coated with an adhesive layer and a release sheet T2 attached to the base sheet through the adhesive layer, such that an attachable label can be produced from the tape T. The label producing apparatus 1 is capable of handling five types of tapes T with a width from 6 mm to 24 mm. There are prepared a plurality of types of tape cartridges C, which are different in the type of the tape T (in terms of tape width, tape color, ink color, tape material, etc.). A plurality of identification holes (not illustrated) identifying the tape type are formed in the back surface of the tape cartridge C. A tape type detection sensor 29 (see FIG. 5) is disposed on the bottom of the cartridge mounting concave 25 such that the type and the width of the tape T housed in the tape cartridge C are determined from the pattern (bit pattern) of identification holes formed in the back surface of the tape cartridge C.

A Braille embossing apparatus 12 (described later) is disposed in the rear case 4. The upper plate of the rear case 4 has a wide cross-shaped cutout 31. A band-shaped tape feeding path 32 along which to transport a tape strip cut off from the tape T (hereinafter, such a tape strip will also be referred to as a tape T) in the longitudinal direction of the rear case 4 is formed at a location facing the cutout 31. The Braille embossing apparatus 12 is partially exposed to the outside through the cutout 31. The tape T is manually inserted into the Braille embossing apparatus 12 through a tape insertion port 33 formed on the right-hand end of the tape feeding path 32 exposed to the outside through the cutout 31, and the tape T is ejected to the outside through an ejection port 34 formed on the left-hand end of the tape feeding path 32 (as will be described in further detail later).

Although in this embodiment, the ink-printing apparatus 11 and the Braille embossing apparatus 12 are disposed in the same apparatus case 2, the front case 3 and the rear case 4 may be formed in a separate fashion and the ink-printing apparatus 11 and the Braille embossing apparatus 12 may be separately disposed in the respective cases. In this case, the front case 3 and the rear case 4 are connected to each other through a cable or the like.

The label producing apparatus 1 is basically configured as follows. That is, the label producing apparatus 1 includes: the ink-printing apparatus 11 for performing ink-printing on the tape T fed out from the tape cartridge C; the Braille embossing apparatus 12 for performing Braille embossing on the tape T; an input unit 13 for inputting data according to which to perform ink-printing and/or Braille embossing; and a control unit (not illustrated) for controlling the ink-printing apparatus 11 and the Braille embossing apparatus 12 (FIG. 5).

The ink-printing apparatus 11 includes cutting means 43 (described later) for cutting the tape T. A piece of a tape cut off from the tape T is manually inserted into the Braille embossing apparatus 12. That is, in the label producing apparatus 1, after ink-printing on the tape T is performed using the ink-printing apparatus 11, an obtained tape strip (a label) is manually inserted into the Braille embossing apparatus 12 to perform Braille embossing thereby producing a Braille label on which the ink-printed character string is also formed.

As shown in FIG. 2, the ink-printing apparatus 11 includes a tape feeding mechanism 41 for feeding the tape T from the tape cartridge C, ink-printing means 42 for performing ink-printing on the tape T fed from the tape cartridge C, and the cutting means 43 for cutting the tape T.

The tape feeding mechanism 41 includes a feed force transmission mechanism for reducing the rotation speed of the feed motor 53 and transmitting the feed force provided by the feed motor 53 to the platen driving shaft 52. The feed force transmission mechanism includes a platen roller 51 of the tape cartridge C, the platen driving shaft 52 engaging with the platen roller 51, a feed motor 53 for rotating the platen driving shaft 52, and a speed reducing gear train (not illustrated). If the feed motor 53 is driven, the platen roller 51 is rotated by the feed motor 53 through the platen driving shaft 52 thereby feeding and transporting the tape T. The driving force supplied by the feed motor 53 is also transmitted to the ribbon take-up shaft 56 through a feed force transmission mechanism such that the platen driving shaft 52 and the ribbon take-up shaft 56 rotate synchronously with each other.

The ink-printing means 42 has the head unit 61 composed of a print head (thermal head) 62 covered with a head cover 63. When the tape cartridge C is mounted in the cartridge mounting concave 25, the head unit 61 is loosely inserted in the through hole C5 and the head unit 61 is located opposing the platen roller 51 through the tape T (facing the through hole C5) and the ink ribbon R. Although not illustrated in the figures, the head unit 61 has a head release mechanism for moving the print head 62 away from or against the platen roller 51 in synchronization with opening or closing of the opening-and-closing cover 21. More specifically, when the opening-and-closing cover 21 is closed, the print head 62 is urged against the platen roller 51 through the tape T and the ink ribbon R which overlap each other at the location exposing to the through hole C5 so that printing on the tape T by means of thermal transfer is possible.

The cutting means 43 includes full cutting means 71 for completely cutting off the tape T and half cutting means 76 for half cutting the tape T such that only the base sheet T1 or the release sheet T2 is cut. The full cutting means 71 includes a cutter (not illustrated) for full cutting disposed so as to face the tape feeding path and a full cut motor 73 for driving this cutter. The half cutting means 76 includes a cutter for half cutting disposed so as face the tape feeding path and a half cut motor 78. The tape T fed from the tape cartridge C is first half cut by the half cutting means 76, and then completely cut by the full cutting means 71. Because the tape strip cut off from the tape T has been subjected to half cutting, it is possible to easily peel off the release sheet T2 from the base sheet T1.

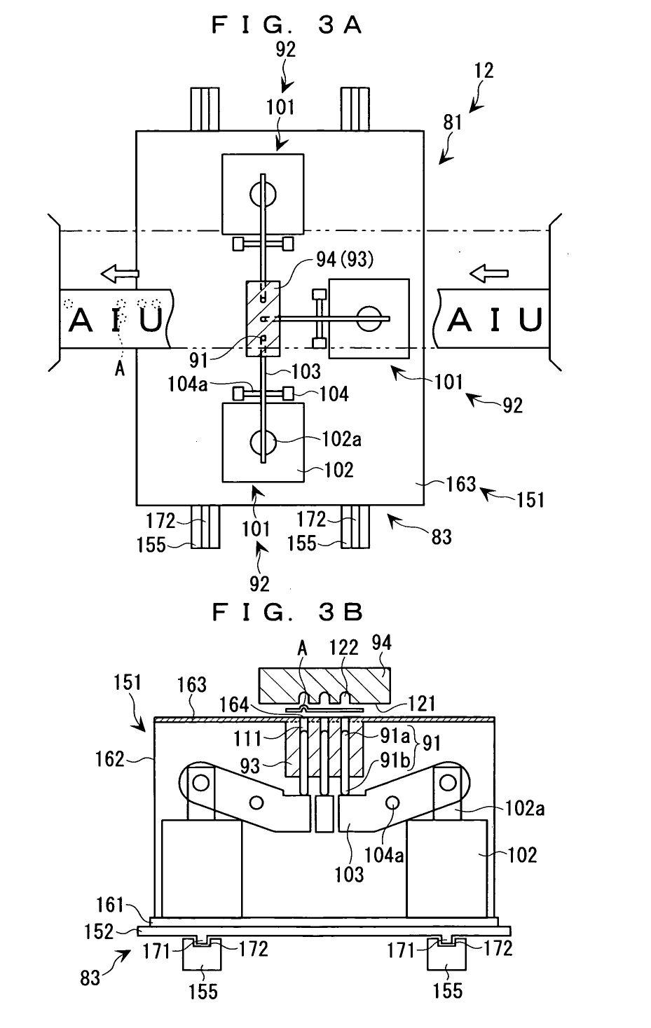

As shown in FIG. 1, FIGS. 3A, 3B, or the like, the Braille embossing apparatus 12 includes: an embossing unit 81 for embossing Braille characters on the tape T (the piece of tape cut off from the tape T); a tape feeding mechanism 82 for feeding the tape T along the tape feeding path 32; and unit moving means 83 for supporting the embossing unit 81 and the tape feeding mechanism 82 such that the embossing unit 81 and the tape feeding mechanism 82 are movable in a direction across the width of the tape feeding path 32 (in a direction perpendicular to a direction in which the tape T is transported). They are combined into the form of a unit and assembled in the apparatus frame 84.

As shown in FIGS. 3A and 3B, the embossing unit 81 includes: three embossing pins 91 for embossing the tape T; embossing driving means 92 for driving the three embossing pins 91; an embossing guide 93 for guiding the embossing pins 91 in the embossing operation; and the embossing pin reception plate 94 for receiving the three embossing pins 91.

Each Braille cell (6-dot Braille cell) is composed of six dots arranged in the form of an array of 3 dots (vertical) by 2 dots (horizontal), and each dot is embossed or not embossed by the embossing unit 81 depending on which Braille character is represented by the cell. The three embossing pins 91 correspond to three vertical dots of one Braille cell, and the pin-to-pin distance is set to be 2.4 mm. The unit moving means 83, which forms a part of the tape feeding path 32, includes a supporting plate 163 (described later) having three loose insertion holes 164 formed at equally spaced locations corresponding to the locations of the vertical three dots of the Braille cell. The three embossing pins 91 are disposed facing, from below, the respective three loose insertion holes 164 (FIG. 3B).

Each embossing pin 91 is made of stainless steel or the like in the form of a substantially circular cylinder. The end (head) 91a of each embossing pin 91 is rounded. As will be described in further detail later, the embossing pin reception plate 94 has three reception recesses 122 with a form corresponding to the form of the end of the embossing pin 91. If the tape T is embossed by the embossing pin 91 in cooperation with the embossing pin reception plate 94, a salient A with a round shape is formed (FIG. 3B). Each embossing pin 91 has a base part 91b in the form of a hemi-sphere supported in a non-fixed manner by a turning arm 103 (described later) of the embossing means 92.

As shown in FIGS. 3A and 3B, the embossing means 92 is composed of three embossing mechanisms 101 corresponding to the respective embossing pins 91 and capable of independently driving the respective three embossing pins 91. Each embossing mechanism 101 includes: a solenoid 102 for providing a driving force of the embossing operation; the turning arm 103 whose one end is fixed to a plunger 102a of the solenoid 102 and the other end of which supports a corresponding embossing pin 91 in a non-fixed manner; and a turning support part 104 for supporting the turning arm 103 such that the turning arm 103 is turnable about a supporting shaft 104a. If any solenoid 102 is excited, a corresponding plunger 102 is linearly moved in a vertical direction, and the end of the turning arm 103 connected to the plunger 102a is moved up and down in the vertical direction together with the plunger 102a. As a result, the turning arm 103 turns about the supporting shaft 104a and a corresponding embossing pin 91 (the end part 91a thereof) appears and disappears from and into the loose insertion hole 164. That is, the solenoid 102 (plunger 102a) and the turning arm 103 forms a link mechanism which converts the linear motion of the plunger 102a to turning motion of the turning arm 103 thereby driving the embossing pin 91 to perform embossing.

As shown in FIG. 3B, the embossing guide 93 has three guide holes 111 communicating with the respective three loose insertion holes 164 and is disposed below the lower surface of the supporting plate 163. Each guide hole 111 is formed to extend vertically through the embossing guide 93 such that the corresponding embossing pin 91 is slidable along the inner wall of the guide hole 111. Thus, the embossing guide 93 vertically supports the embossing pins 91 placed on the respective turning arms 103 in the non-fixed manner and guides the respective embossing pins 91 when the embossing pins 91 move vertically such that the end part of each embossing pin 91 appears and disappears from and into the corresponding loose insertion hole 164.

As shown in FIG. 3B, the embossing pin reception plate 94 has an embossing reception surface 121 which is for receiving the three embossing pins 91 and which is located facing the three loose insertion holes 164 formed in the supporting plate 163. On the embossing reception surface 121, three reception recesses 122 having a shape complementary to the shape of the end of the embossing pin 91 are formed at locations corresponding to the locations of the respective loose insertion holes 164. The other surface, opposite to the embossing reception surface 121, of the embossing pin reception plate 94 is connected to an impact absorption spring (not illustrated).

If any embossing mechanism 101 (the solenoid 102) is driven, the corresponding embossing pin 91 moves along the guide hole 111 and the end thereof appears from the corresponding loose insertion hole 164. As a result, the end 91a of the embossing pin 91 strikes the reception recess 122 through the tape T (the end 91a of the embossing pint 91 is brought into the reception recess 122), and thus a salient A is formed on the tape T. The salient A can be formed to have an arbitrary shape by modifying the shape of the embossing pin 91 and the shape of the reception recess 122. For example, a salient A with a hemi-spherical shape can be formed by modifying the shape of the end of the embossing pin 91 into a hemi-sphere and the shape of reception recess 122 into a hemi-sphere.

Although in this embodiment, the embossing unit 81 is designed to form 6-dot Braille characters, the embossing unit 81 may be designed to form 8-dot Braille characters. In this case, instead of three embossing pins 91, four embossing pins are used.

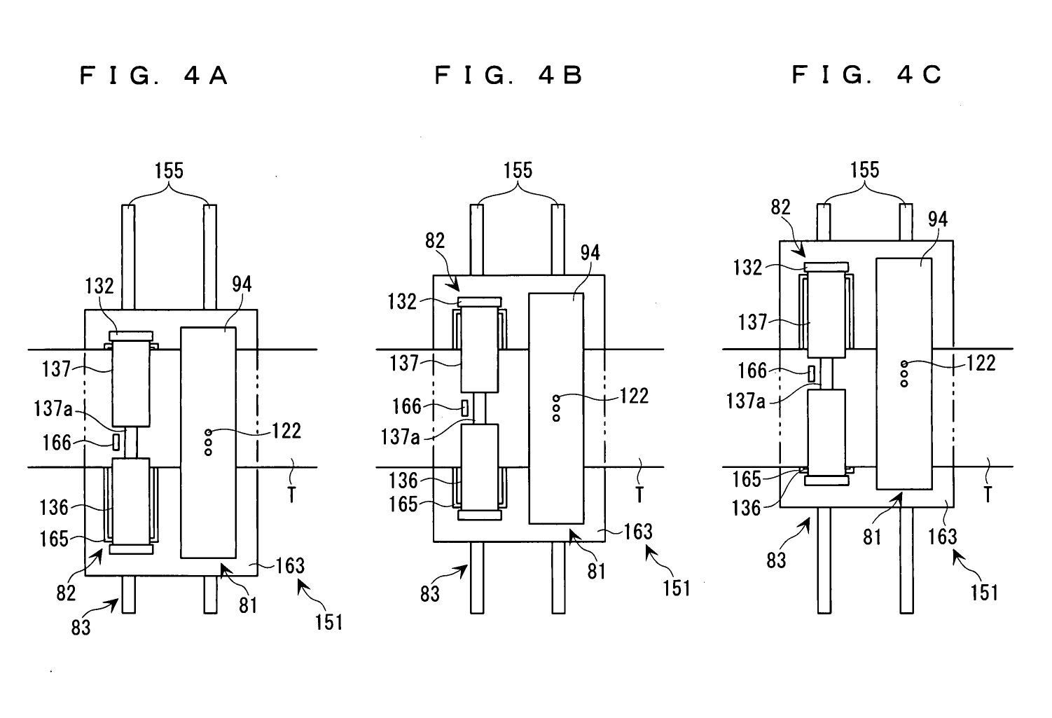

As shown in FIGS. 1, 4A-4C, the tape feeding mechanism 82 includes feed rollers 131 which are for feeding the tape T and which are disposed downstream, in the direction in which the tape T is fed, of the tape feeding path on the embossing unit 81, and also includes supporting parts 132 for supporting the respective feed roller 131, and a feed motor 133 (not illustrated) for rotating the feed rollers 131. When the tape T is manually inserted through the tape insertion port 33, the tape T is transferred to the tape feeding mechanism 82, which transports the tape T to the embossing unit 81 and further to the ejection port 34.

The feed rollers 131 are in the form of grip rollers composed of a driving roller 136 located below the supporting plate 163 and a follower 137 located above the supporting plate 163, and the feed rollers 131 are supported by the supporting plate 163 of the unit moving means 83 through the supporting parts 132. An output gear (not illustrated) for transmitting the driving force from the feed motor 133 is axially fixed to a shaft of the driving roller 136 so that the driving roller 136 rotates as the output gear rotates. The follower 137 is a free roller that rotates following the rotation of the driving roller 136. As shown in FIGS. 1, 4A-4C, the follower 137 has a narrow part 137a along the axial direction so that salients A formed on the tape T are not brought into contact with the follower 137 thereby preventing the salients A from being collapsed.

In this embodiment, the tape T is transported along the tape feeding path 32 while maintaining the position of the tape T such that one side end of the tape T is aligned with one side end of the tape feeding path 32. To this end, the apparatus frame 84 has a one-side alignment mechanism 141 which is located close to the tape insertion port 33 and which serves to guide the tape T during the transportation of the tape T such that the position of one side end of the tape T is maintained at the one side end of the tape feeding path 32. As shown in FIGS. 1 and 2, the one-side alignment mechanism 141 includes a fixed guide 142 located at the one side end (front side end in FIG. 1), with which to align the one side end of the tape T, of the tape feeding path 32, and also includes a movable guide 143 slidable in a direction across the width of the tape feeding path 32. The tape T is first placed manually on the tape feeding path 32 such that the one side end of the tape T is in contact with the fixed guide 142, and then the movable guide 143 is moved until the movable guide 143 comes into contact with the other side end of the tape T, such that the position of the tape T in the width direction is restricted by the fixed guide 142 and the movable guide 143.

The unit moving means 83 is for moving the embossing unit 81 and the tape feeding mechanism 82 in the direction across the width of the tape feeding path 32 to form the salient A (Braille character) at an arbitrary desirable position in the direction perpendicular to the direction in which the tape T is transported (that is, at an arbitrary position in the direction across the width of the tape feeding path 32). As shown in FIGS. 3 and 4, the unit moving means 83 includes: a common supporting frame 151 for supporting the embossing unit 81 and the tape feeding mechanism 82: a slider 152 for supporting the common supporting frame 151 such that the common supporting frame 151 is slidable in the direction across the width of the tape feeding path 32; a lead screw (not illustrated) for moving the slider 152; a motor 154 (not illustrated) for rotating the lead screw in forward and reverse directions; and a slide guide pair 155 for guiding the slider 152.

As shown in FIGS. 3A, 3B, the common supporting frame 151 is composed of the supporting plate 163 firmly placed on a supporting frame 162 which is firmly placed on a base plate 161 fixed to the slider 152. The embossing means 92 is disposed on the base plate 161. The upper surface of the supporting plate 163 is flush with the tape feeding path 32 formed on the apparatus frame 84 such that the upper surface of the supporting plate 163 forms a part of the tape feeding path 32. The supporting plate 163 has the three loose insertion holes 164 formed in a line across the width the of tape feeding path 32 (in the direction perpendicular to the direction which the tape is transported) such that the embossing pins 91 can be loosely inserted into corresponding holes 164. The embossing pin reception plate 94 is fixed with screws to the supporting plate 163 such that the embossing pin reception plate 94 faces, from above, the loose insertion holes 164.

The supporting plate 163 also has a roller opening 165 formed at a location apart, in the direction in which the tape is transported, from the loose insertion holes such that the feed rollers 131 face each other through the roller opening 165. The follower 137 is disposed such that the three narrow parts 137a of the follower 137 are located at positions corresponding to the locations of the three loose insertion holes 164 formed in a line across the width of the tape feeding path 32. Furthermore, on the supporting plate 163, leading end detection sensors 166 of transmission type for detecting the leading end of the tape T are disposed at locations apart, in the direction in which the tape T is transported, from the follower 137 and corresponding to the three loose insertion holes 164 spaced apart in the direction across the width of the tape feeding path 32. That is, the three loose insertion holes 164, the narrow parts 137a, and the leading end detection sensors 166 are respectively located in lines in the direction in which the tape T is transported.

A pair of elongated protrusions 171 each extending in the direction across the width of the tape feeding path 32 are formed on the lower surface of the slider 152. The lead screw and the pair of slide guides 155 extend in the direction across the width of the tape feeding path 32 beyond the side edges of the tape feeding path 32. The upper surface of each slide guide 155 has a groove 172 in which one of pair of elongated protrusions 171 formed on the slider 152 fits. A DC motor with an encoder is used as the motor 154.

The unit moving means 83 moves the embossing unit 81 and the tape feeding mechanism 82 in the direction across the width of the tape feeding path 32 in order to form salients A at arbitrary desired positions (in the direction across the width of the tape feeding path 32) on the tape T while preventing the formed salients A from collapsed by the feed rollers 131.

More specifically, the unit moving means 83 moves the embossing unit 81 and the tape feeding mechanism 82 in the direction across the width of the tape feeding path 32 with respect to the tape T whose position in the direction across the width of the tape feeding path 32 is constrained by the one-side alignment mechanism 141, so that the embossing pins 91 (loose insertion holes 164) and the embossing pin reception plate 94 come to arbitrary positions on the tape T in the direction across the width of the tape feeding path 32.

Although in this embodiment, the embossing unit 81 and the tape feeding mechanism 82 are moved with respect to the tape T, the embossing unit 81 and the tape feeding mechanism 82 may be maintained at fixed positions and the tape T may be moved in the direction across the width of the tape feeding path 32. In this case, a guide mechanism for guiding the position of the tape T in the direction across the width of the tape feeding path 32 is disposed, and the tape T is moved along the guide mechanism depending on the width of the tape T and the positions at which to form salients so that the tape T comes to a position that allows salients A to be formed at desired positions with respect to the embossing unit 81 and the tape feeding mechanism 82.

The input unit 13 includes a keyboard 181 and a display 191 (FIG. 1). The keyboard 181 includes character keys 182 and functions keys 183 (such as selection keys, a cancel key, cursor keys, a print key, an embossing key, etc.) for specifying various operation modes or the like. The keyboard 181 is used to input textual information according to which to perform ink-printing and/or Braille embossing, and also used to select various operation modes or issue operation commands. The display 191 has a rectangular-shaped display screen with a size of 10 cm (in a horizontal (X) direction)×4 cm (in a vertical (Y) direction) including 200 pixels×64 pixels. Textual information inputted through the keyboard 181 and other information are displayed on the display 191. In accordance with information displayed on the display 191, a user can input and edit ink-print data and/or Braille data. The display 191 is also used to display an error message or other messages to be notified to the user. The input unit 13 also has an interface (not illustrated) for connection with an external apparatus through the connector 23. This interface makes it possible to perform two-way data (information) communication with the external apparatus to input textual information produced by the external apparatus.

Next, the control system of the label producing apparatus 1 is explained below. As shown in FIG. 5, the label producing apparatus 1 includes: an operation control unit 201 including the keyboard 181 and the display 191 and serving as a user interface through which to input and display textual information and other various kinds of information; the ink-printing unit 202 including the ink-printing means 42 and the tape feeding mechanism 41 and serving as a unit for performing ink-printing on the tape T while feeding the tape T; a cutting unit 203 including the full cutting motor 73 and the half cutting motor 78 in the cutting means 43 and serving as a unit for cutting the tape T fed from the tape cartridge C; a Braille embossing unit 204 including the embossing means 92 (solenoids 102); the tape feeding mechanism 82 and the unit moving means 83 and serving as a unit for embossing Braille characters on the tape T while feeding the tape T; a detection unit 205 including the tape type detection sensor 29 and the leading end detection sensor 166 and serving as a unit for performing various detections; a driving unit 206 including various drivers for driving various parts; and a controller 207 (control apparatus 14) connected to various units and serving as a unit for controlling the whole label producing apparatus 1.

The controller 207 includes a CPU 211, a ROM 212, a RAM 213, and an input/output controller (10C) 214, which are connected to each other through an internal bus 215. The ROM 212s has a control program block 221 for storing control programs executed by the CPU 211 to perform various processes including a Braille embossing process, and a control data block 223 for storing a conversion table 222 used in conversion of data inputted through the input unit 13 to Braille data and also storing control data used to control embossing of Braille data.

The RAM 213 is used as a working area during control processes and includes: various working area blocks 231 for storing flags and other data; an input data block 232 for storing data inputted through the input unit 13; a Braille data block 233 for storing generated Braille data; and a display data block 234 for storing display data to be displayed on the display 191. The RAM 213 is always backed up to retain stored data even if power is turned off.

The IOC 214 includes a logic circuit, implemented in the form of a gate array or a custom LSI, for assisting the operation of the CPU 211, in particular, in handling a signal to interface with peripheral circuits. More specifically, if the IOC 214 receives data such as data inputted through the keyboard 13 or control data, the IOC 214 outputs the received data over the internal bus 215 directly or after processing the data. On the other hand, if the IOC 214 receives data or a control signal from the CPU 211 through the internal bus 215, the IOC 214 outputs the data or the control signal to the driving unit 206 directly or after processing the data or the control signal.

In accordance with the control program stored in the ROM 212, the CPU 211 receives through the IOC 214 various signals or data In accordance with the received signal or data, the CPU 211 processes data stored in the RAM 213. The CPU 211 outputs various signals or data to various parts through the IOC 214 to control the ink-printing operation and the Braille embossing operation.

For example, the controller 207 controls the unit moving means 83 so as to move the embossing unit 81 and the tape feeding mechanism 82 to a particular position and drives the embossing means 92 (the solenoids 102) and the tape feeding mechanism 82 synchronously in accordance with a detection signal output from the leading end detection sensor 166 so as to form salients A (6-dot Braille characters) on the tape T, at vertical intervals of 2.4 mm and at horizontal intracell intervals of 2.1 mm and intercell intervals of 3.3 mm, at arbitrarily specified positions.

Next, a method of producing a label using the label producing apparatus 1 in accordance with this embodiment is described below. A program (software) for producing a label (label data) is stored in the controller 207 (ROM 212). When electric power of the label producing apparatus 1 is turned on, an input/edit screen 301 for use in producing label data is displayed on the display 191. After producing label data by inputting textual information and editing it as required through the input/edit screen 301, if a particular key (selection key) is pressed, the ink-printing apparatus 11 and Braille embossing apparatus 12 are driven in accordance with the label data, and a label is produced.

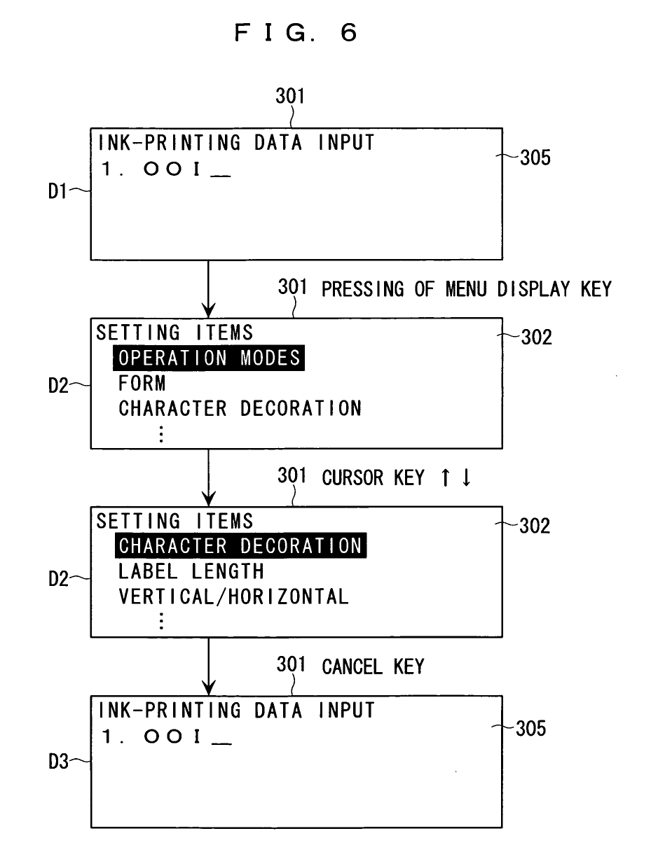

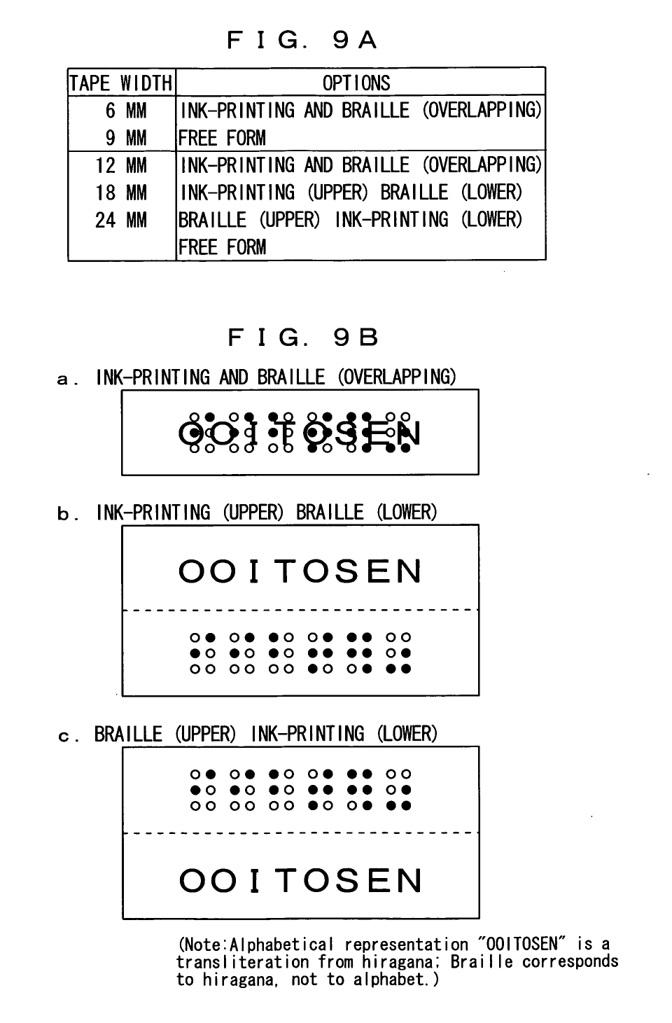

The keyboard 181 has a menu display key as one of function keys. When an ink-printing data input screen 305 (Braille data input screen 306) is displayed as shown in FIG. 6 (D1), if the menu display key is pressed, the screen changes from the input/edit screen 301 to a setting item selection screen 302 (D2) having setting items “operation mode”, “form”, “character decoration”, and “label length” displayed in the form of a menu. (Note: Characters (“OOI”) on the screen (D1, D3) are part of Japanese hiragana as transliterated into alphabetical representation “OOITOSEN” which is the name of a Japanese local railway line and which is to be illustrated in FIGS. 9B, 10B, 12 and 13B. Braille characters therein correspond to hiragana, not to alphabets.) An arbitrary item can be selected by using cursor keys and a selection key. This is also true for other menu screens described elsewhere. When the setting item selection screen is displayed (D2), if a particular key (cancel key) is pressed, the setting is ended and the screen returns to the ink-printing data input screen 305 (or the Braille data input screen 306) (D3).

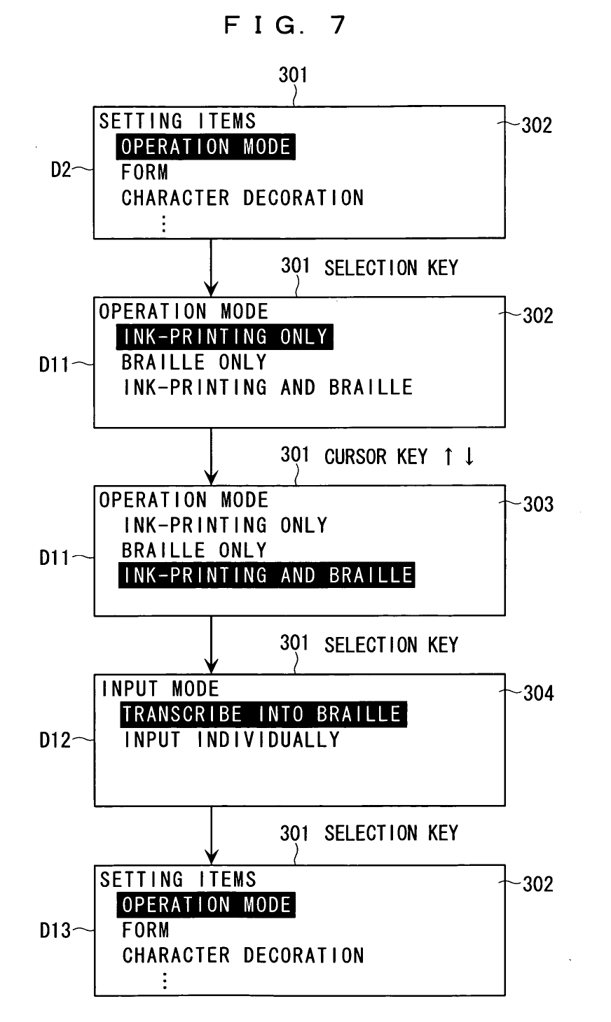

The menu item “operation mode” is for setting the operation mode depending on the type of characters to be formed on the label. As shown in FIG. 7, when the screen D2 is displayed, if “operation mode” is selected, a mode setting menu (mode selection screen 303) is displayed on the input/edit screen 301 to allow a user to select an operation mode from options “ink-printing only”, “Braille only”, and “ink-printing and Braille” (D11). The display 191 has an indicator (not illustrated) indicating which operation mode is selected.

After the “ink-printing only” mode is selected, if the mode setting menu is closed, an ink-print data input screen 305 for inputting ink-print data including characters and/or numerals appears. In a case in which the mode setting menu is closed after the “Braille only” mode is selected, a Braille data input screen 306 for inputting Braille data appears. As shown in FIG. 7, in the case in which the “ink-printing and Braille” mode is selected, an input mode selection menu (input mode selection screen 304) is displayed on the input/edit screen 301 (D12). On this screen, a user is allowed to select a “transcribe into Braille” mode in which the same textual information is ink-printed and embossed in Braille or an “input individually” mode in which Braille data and ink-printing data are allowed to be inputted independently. In the “transcribe into Braille” mode, Braille data is produced in accordance with text data inputted through the ink-printing data input screen 305. In the case in which the “input individually” mode is selected, if a particular key is pressed, the screen is toggled between the ink-printing data input screen 305 and the Braille data input screen 306. Note that the “ink-printing only” mode is selected by default as the operation mode, and thus the ink-printing data input screen 305 appears when electric power of the label producing apparatus 1 is turned on.

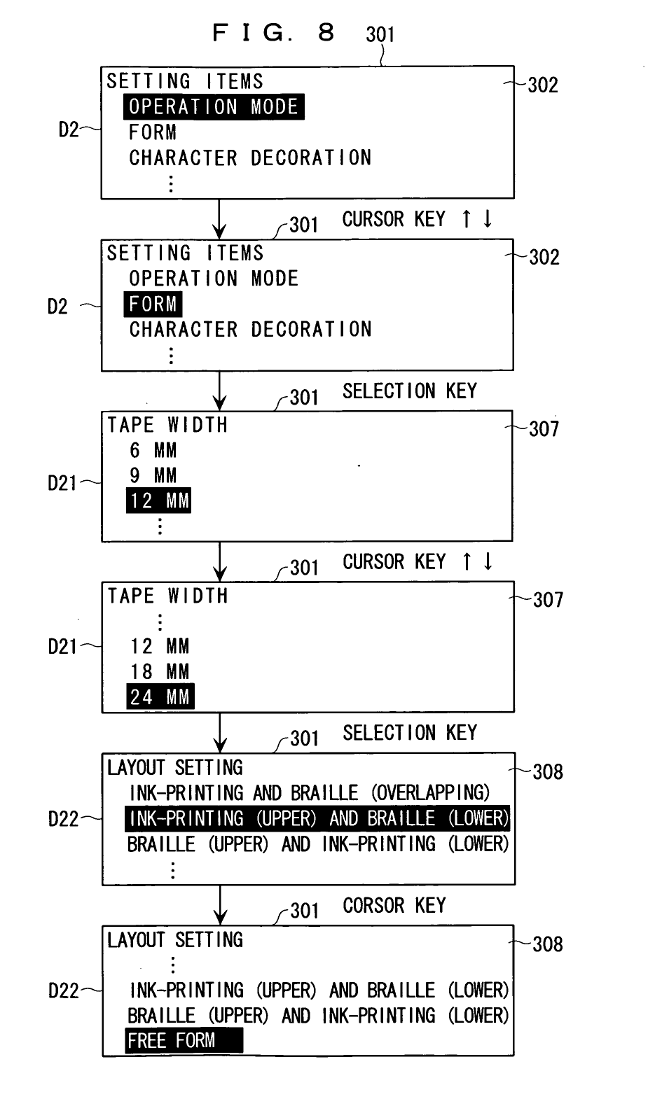

The menu item “form” is for setting the layouts of the ink-printing characters and the Braille characters, that is, positions of the ink-printing area and the Braille embossing area when the “ink-printing and Braille” mode is selected on the mode setting screen. As shown in FIG. 8, if the “form” is selected on the screen D2, a tape width selection screen 307 (D21) indicating a list of widths (6 mm to 24 mm) of the tape T supported by the label producing apparatus 1 is displayed on the input/edit screen 301. The width of the tape T detected by the tape type detection sensor 29 is selected as a default width. If a user selects a width of the tape T to be used to produce a label, a layout setting menu (layout setting screen 308) for setting the layouts of the ink-printing characters and the Braille characters appears (D22).

As shown in FIGS. 9A and 9B, the layout setting menu includes options: a “Braille and ink-printing (overlapping)” mode in which ink-printed characters and Braille characters are formed in an overlapping area (that is, the ink-printing area and the Braille embossing area overlap each other); an “ink-printing (upper) and Braille (lower)” mode in which ink-printed characters are formed in an upper area of the tape T and Braille characters are embossed in a lower area (that is, the ink-printing area is positioned in the upper area of the tape T and the Braille embossing area is positioned in the lower area); a “Braille (upper) and ink-printing (lower)” mode in which Braille characters are embossed in an upper area of the tape T and ink-printed characters are formed in an lower area (that is, the Braille embossing area is positioned in the upper area of the tape T and the ink-printing area is positioned in the lower area; and a “free form” mode in which ink-printed characters and Braille characters are formed at arbitrary positions. For tapes T with a width of 6 mm or 9 mm, the “ink-printing (upper) and Braille (lower)” mode and the “Braille (upper) and ink-printing (lower)” mode are disabled.

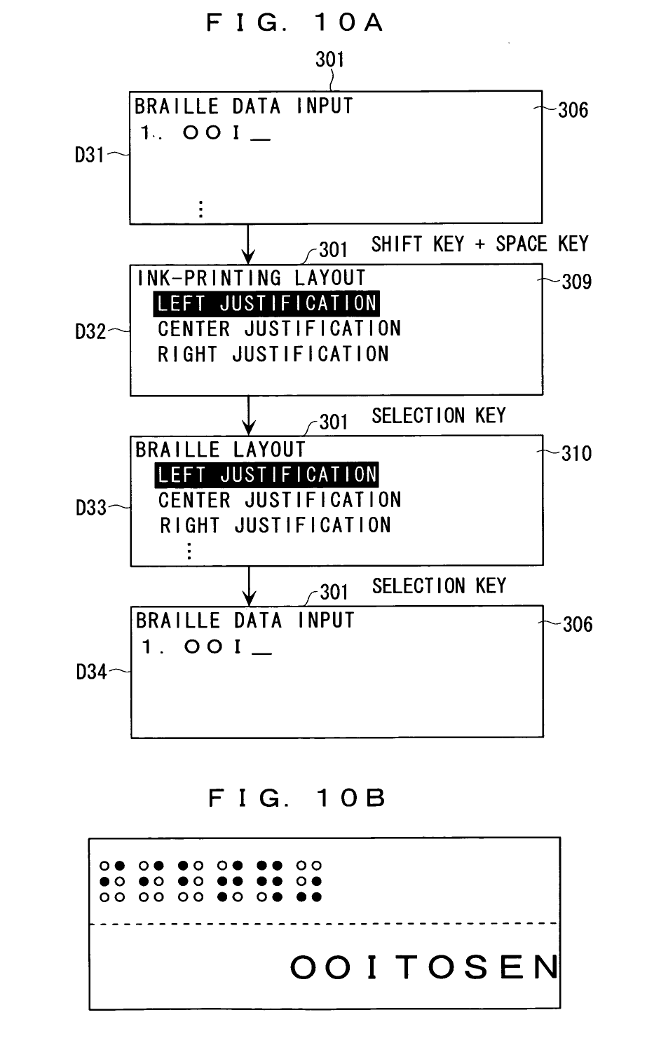

In the case in which the “Braille and ink-printing (overlapping)” mode, the “ink-printing (upper) and Braille (lower)” mode, or the “Braille (upper) and ink-printing (lower)” mode is selected, if a particular key is selected when the ink-printing data input screen 305 of the Braille data input screen 306 is displayed (D31), the layout menu is displayed, which allows it to select one of formats “left justification”, “center justification”, and “right justification” to specify the position the ink-printed characters (the ink-printing area) and the Braille characters (the Braille embossing area). Note that the layouts of the ink-printed characters and the Braille characters are set depending on the length of the label which is set in the menu item “label length” as will be described later. As shown in FIG. 10A, if a particular key (for example, shift key+space key) is pressed, an ink-printing layout setting screen 309 for setting the ink-printing layout is first displayed (D32). When the setting of the ink-printing layout is completed, a Braille layout setting screen 310 for setting the Braille layout is displayed (D33). Note that the “left justification” format is selected by default for both the ink-printing layout and the Braille layout. That is, immediately after the “Braille and ink-printing (overlapping)” mode, the “ink-printing (upper) and Braille (lower)” mode, or the “Braille (upper) and ink-printing (lower)” mode is selected, the layouts for the ink-printed characters and the Braille characters are automatically set to the “left justification” format. FIG. 10B illustrates an example of a label produced when “Braille (upper) and ink-printing (lower)”, “left justification” for a Braille character string, and “right justification” for an ink-printing character string are selected

When one of an ink-printed character string and a Braille character string is longer than the other, the other character string with a shorter length may be “left-justified”, “center-justified”, or “right-justified” with respect to the character string with the longer length. For example, when an ink-printed character string is longer, if the “left justification” format is selected, the leading end of the Braille character string is aligned with the leading end of the ink-printed character string. If the “center justification” is selected, the Braille character string is aligned such that the center of the Braille character string comes is coincident with the center of the ink-printed character string.

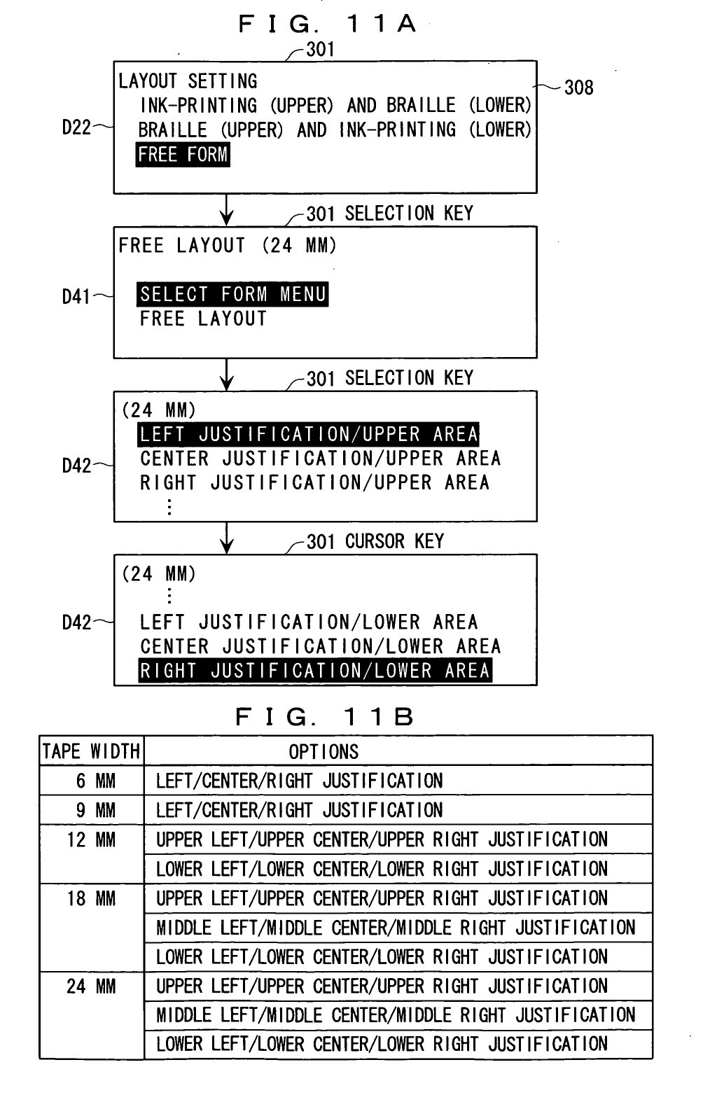

As shown in FIG. 11A, if the “free form” format is selected on the screen D22, a lower-level menu is displayed, which allows a user to select a relative position on the tape T from options “select from menu” for selecting one of a position for the ink-printed character string and the Braille character string from a menu and “free position” for directly specifying the position for the ink-printed character string and the Braille character string (D41).

When “select from menu” is selected, options associated with the relative position depending on the width of the tape T selected on the screen D21 (the tape width selection screen 307) are displayed on the input/edit screen 301 (D42). If a relative position for the ink-printed character string is selected from the displayed options, options associated with the relative position for the Braille character string are displayed on the input/edit screen 301. For example, when “24 mm” is selected as the tape width on the screen D21, options “left justification in upper area”, “center justification in upper area”, “right justification in upper area”, “left justification in middle area”, . . . , “right justification in lower area” are displayed on the input/edit screen 301 (FIG. 11B).

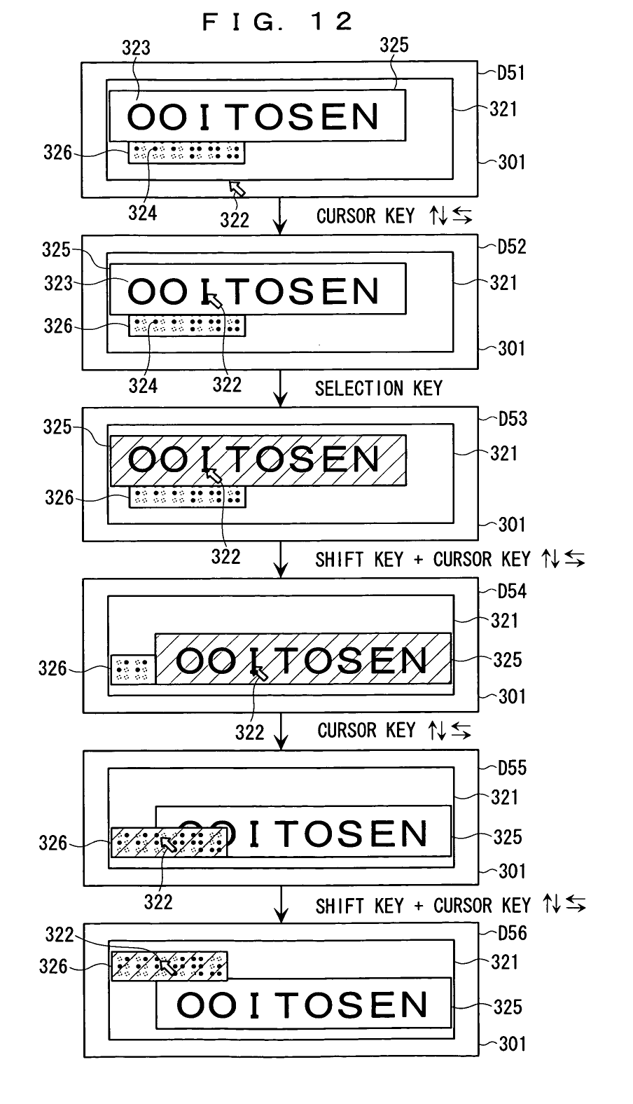

As shown in FIG. 12, when the “free position” is selected on the screen D41, a frame 321 with a rectangular shape (similar to the shape of a label to be produced) representing the outline of the label to be produced and a pointer 322 are displayed on the input/edit screen 301 of the display 191 (D51). Inside the frame 321, an image 323 of an ink-printed character string corresponding to text data inputted through the ink-printing data input screen, a box indicating the ink-printing area 325, an image 324 of a Braille character string corresponding to text data inputted through the Braille data input screen 306, and a box indicating the Braille embossing area 326 are displayed. After the image 323 of the ink-printed character string or the image 324 of the Braille character string is selected with the point 322 (D52, D53, and D55), if a particular key (for example, shift key+cursor key) is pressed, the selected image 323 or 324 is dragged to a desired position (D54 and D56). In this case, it is required that the length of the label to be produced be set in the setting menu “label length” in advance.

As descried above, the setting menu “form” allows a user to lay the ink-printed character string and the Braille character string at arbitrary desired positions on a label, and thus it becomes possible to produce a label in a desirable form depending on the purpose of the label. In particular, the capability of laying the Braille character string at an arbitrary position makes it possible to produce a label in a form that allows vision-impaired persons to easily recognize the Braille characters. For example, when a label is attached to a handrail with a circular shape in cross section, it is desirable that a Braille character string be formed at the center in the direction across the width of a label and the label be attached to the handrail such that the Braille character string is located on the top of the handrail. This allows vision-impaired persons to easily touch the Braille character string, and also makes it possible for the label to be strongly adhered to the handrail. In a case in which a label is attached to a handrail of stairs, it is desirable to produce the label such that the Braille character string is located on a front side, in the ascending (or descending) direction of the stairs, of the label thereby allowing vision-impaired persons to easily recognize the ascending (descending) start position of the stairs.

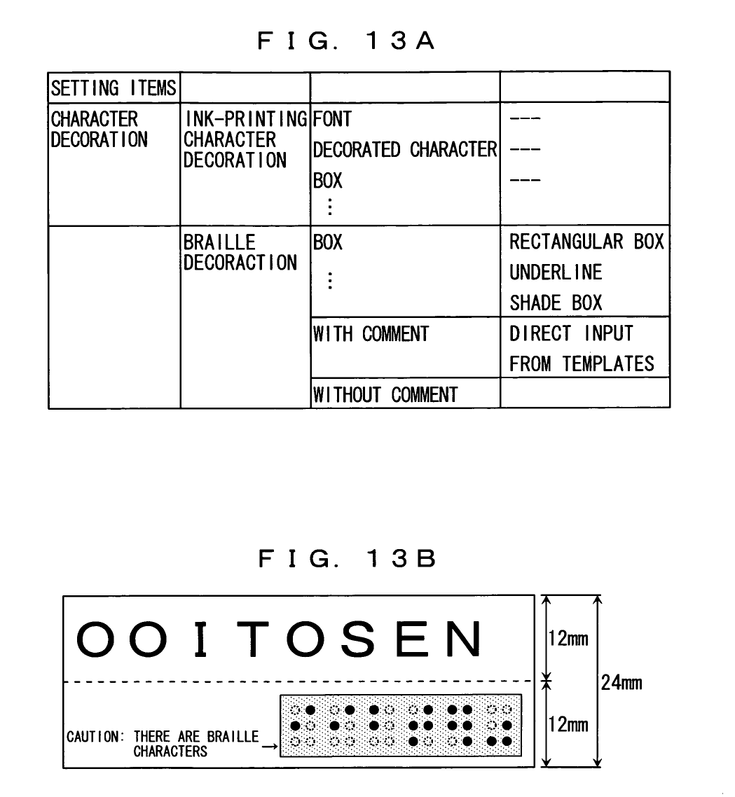

The menu item “character decoration” is for setting decoration of an ink-printed character string and/or a Braille character string. If the menu item “character decoration” is selected, lower-level options “ink-printed character decoration” and “Braille character decoration” are displayed (FIG. 13A). In “ink-printed character decoration”, it is possible to set the font (Mincho, Gothic, etc.), the decoration (hollow, shaded, etc.), and/or the box enclosing the ink-printed character string (rectangular box, round box, shaded box, etc.). In the menu item “Braille character decoration”, it is possible to set the box enclosing the Braille character string (the Braille embossing area) and/or specify whether to input a comment (in ink-printed characters) to indicate the position of the Braille character string. The comment may be produced in accordance with text data inputted by a user or may be selected from prepared templates such as “Braille”, “There are Braille characters”, etc. It is possible to select a position at which to insert the comment from options “left end”, “right end”, “top”, and “bottom” of the Braille character string, depending on the position of the Braille character string (the Braille embossing area) or the purpose of the label.

The menu item “label length” is for setting the length of a label to be produced. The options of “label length” include “automatic setting” for automatically setting the label length depending on the length of the ink-printed character string and/or the Braille character string inputted by a user, and “fixed length” for setting the label length to a predetermined value. The “fixed length” menu has a submenu for selecting a length from options of length predetermined depending on an object the label is to be attached to. They include “MD”, “music tape (cassette tape)”, “video tape”, and “B5 file”. The options include values represented in cm in the range, for example, from 1.0 cm to 95 cm.

The setting items may also include “character size” for setting the character size of ink-printed characters, “vertical/horizontal writing” for specifying whether to write characters vertically or horizontally, “margins” for setting margins of the ink-printed character string and/or the Braille character string, etc. When the setting of any item is ended, the setting item display menu (the setting item selection menu 302) is again appears to allow it to further set another item.

A specific example of a method of producing a label using the label producing apparatus 1 is described below for a case in which an ink-printed character string and a Braille character string are formed on the label in the “transcribe into Braille” mode. In this example, it is assumed that a label similar to that shown in FIG. 13B is produce using a tape T with a width of 24 mm. The label shown in FIG. 13B is intended to be attached to a handrail or the like in a station, and both a Braille character string and an ink-printed character string representing “OOITOSEN” are formed on the label.

First, on the ink-printed data input screen 305, ink-printing data of the ink-printed character string (“OOITOSEN” in this example” to be printed on the label is inputted by pressing keys on the keyboard. The menu display key is then pressed to switch the input/edit screen 301 (ink-printing data input screen 305) to the setting item selection screen 302. The “ink-printing and Braille” mode is selected from the setting item display menu (the mode selection screen 303). On the input mode selection screen 304 which is displayed in response to the selection of “ink-printing and Braille” mode, the “transcribe into Braille” mode is selected.

If the “transcribe into Braille” mode is selected, the setting item display menu (the setting item selection screen 302) is again appears. On the setting item display menu, “form” is selected to display the tape width selection screen 307. On this screen, a width of “24 mm” is selected. From the layout setting menu (the layout setting screen 308) which appears in response to selection of the tape width, “ink-printing (upper) and Braille (lower)” is selected. Furthermore, in the “character decoration” menu, “Braille character decoration”→“box/shaded”→“shaded” are sequentially selected, and in the “comment setting” menu, “insert comment”→“select from template”→“Caution: There is a Braille character string.” are sequentially selected. Furthermore, in the “label length” setting menu, the “automatic setting” is selected.

After the setting is completed, if a particular key (for example, the cancel key) is pressed, the input/edit screen 301 is switched to the ink-printing data input screen 305 (or the Braille data input screen 306). The ink-printing layout setting screen 309 is then displayed on the input/edit screen 301 by pressing the particular key. The “left justification” format is selected as the format of the ink-printed character string. Furthermore, the “right justification” format is selected as the layout of the Braille character string on the Braille layout setting screen 310.

Thereafter, if the print key on the keyboard 181 is pressed, the ink-printing apparatus starts an ink-printing process. After the ink-printing process is completed, and the tape T is cut into a tape strip. The tape strip cut off from the tape T is manually inserted into the Braille embossing apparatus 12. If the embossing key on the keyboard 181 is pressed, the Braille embossing apparatus 12 starts an embossing operation to produce the label shown in FIG. 13B. Although in this embodiment, the character string “OITOSEN” is ink-printed in the alphabet, the character string may be ink-printed in another type of characters or in another language such as Japanese kanji or the like. Furthermore, although in this embodiment, the “ink-printing (upper) and Braille (lower)” format is selected from the layout setting menu in the production of the label, a similar label may also be produced by selecting the “free form” format. Furthermore, although in this embodiment, setting of respective items is performed after the ink-printing data to be ink-printed on the label is inputted, the order of processing is not limited to that employed in this embodiment.

Next, a label producing apparatus 1 according to a second embodiment is described below. The label producing apparatus 1 according to the second embodiment is similar to that according to the first embodiment except that it is not allowed to separately specify the content of the ink-printed character string and the content of the Braille character string. That is, only the “transcribe into Braille” described in the first embodiment is available. When the “ink-printing and Braille” mode is selected from the operation mode selection menu, the “transcribe into Braille” mode is automatically selected, the input/edit screen 301 is switched to the setting item selection screen 302.

In the first embodiment, the ink-printing operation starts when the pint key is pressed after the setting of (all) items is completed. In this embodiment, in contrast, after the inputting of the ink-printing data is completed, if the print key is pressed, the “operation mode” setting menu appears. The setting of “form” and “Braille character decoration” is performed after the “ink-printing and Braille” mode is selected in the “operation mode” selection menu. However, the setting of “ink-printed character decoration” and the “label length” is possible before the print key is pressed.

In this embodiment, as described above, when the print key is pressed, the mode selection screen 303 for selecting the “operation mode” is displayed, and thus it is possible to prevent the setting of the operation mode from being forgotten. This ensures that the label is produced correctly in an intended form.

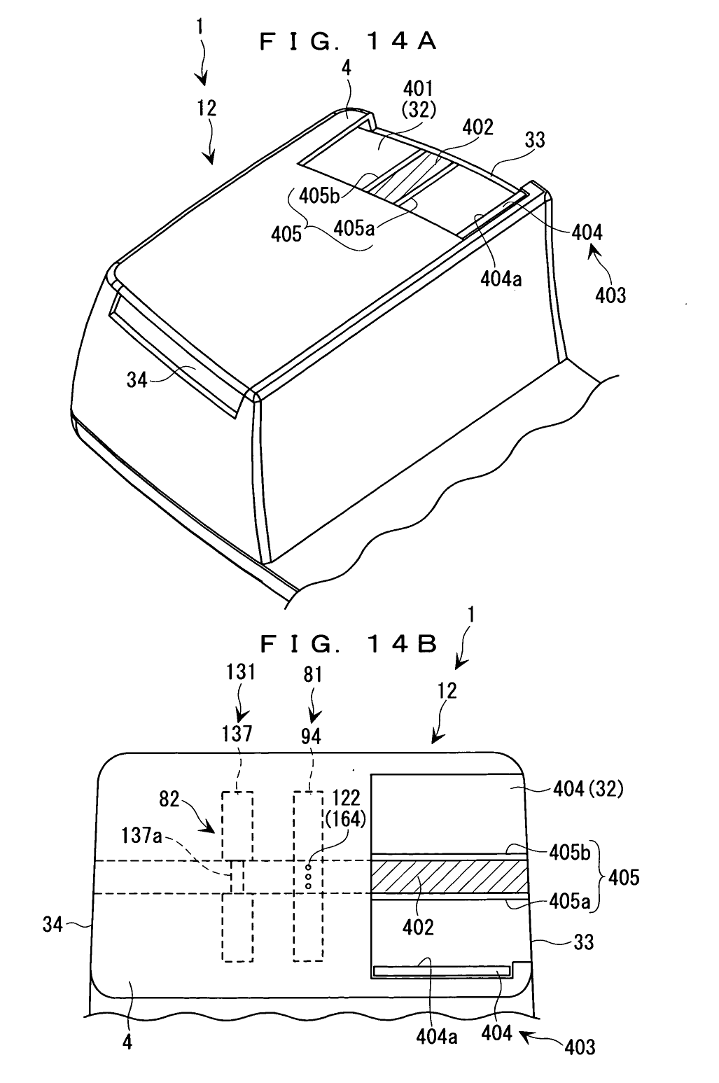

Next, a label producing apparatus 1 according to a third embodiment is described below. The label producing apparatus 1 according to the third embodiment is similar in structure to that according to the first embodiment except that the Braille embossing apparatus does not have the unit moving mechanism, and that the position of the tape in the direction across the width of the tape feeding path is set manually by a user. More specifically, the position of the tape relative to the fixed position of the embossing unit and the tape feeding mechanism is manually set by the user so that the Braille character string is formed at a desirable position in the direction across the width of the tape. Referring to FIGS. 14A and 14B, the third embodiment is described below. In the following explanation, the discussion is focused on the difference from the first embodiment.

As shown in FIGS. 14A and 14B, the rear case 4 in which the Braille embossing apparatus 12 is disposed has a cutout on the right-hand side end along almost the entire length of the width so that a large portion of a feed support plate 401 forming the tape feeding path 32 is exposed to the outside through the cutout. In a region covered with the rear case 4, the feed support plate 401 has three loose insertion holes 164 in which to loosely insert the respective three embossing pins 91 of the embossing unit 81, and the embossing pin reception plate 94 is disposed so as to face the loose insertion holes 164. The feed roller 131 of the tape feeding mechanism 82 is disposed on a downstream side of the embossing pin reception plate 94 of the feed support plate 401.

As shown in FIGS. 14A and 14B, the exposed part of the feed support plate 401 serves as a tape insertion port 33 through which to insert the tape T. On the feed support plate 401 in the tape insertion port 33, an embossing position indication line 402 is formed to indicate the embossing position at which embossing is performed by the three embossing pins 91, and a guide mechanism 403 for guiding one side end (the front side end in FIG. 14) of the tape T is disposed.

The embossing position indication line 402 is formed on the feed support plate 401, at the substantially central position in the direction perpendicular to the direction in which the tape is fed such that the embossing position indication line 402 extend in the direction in which the tape is fed. The embossing position indication line 402 is in the form of a band indicating the range in which the three embossing pins 91 (the three loose insertion holes 164) arranged in the direction across the width of the tape T, so that user can determine the position at which to manually insert the tape T with respect to the embossing position indication line 402. The guide mechanism 403 has a guide part 404 substantially similar to the variable guide 143 of the one-side alignment mechanism 141 described above. The guide part 404 has a guide surface 404a perpendicular to the tape feeding path 32 (feed support plate 401) and parallel to the direction in which the tape is fed. The user can slide the guide part 404 to a proper position in the direction across the width of the tape so that one side end of the tape T is correctly guided by the guide surface 404a.

The feed support plate 401 has a pair of limit lines 405 which are formed on both side ends of the embossing position indication line 402 and which extend in a direction parallel to the embossing position indication line 402. The pair of limit lines 405 indicate the limit of the position of each side end of the tape T. If one of the side ends of the tape T is located outside one of the limit lines 405 in the direction across the width of the tape T, Braille characters are not embossed at correct positions within the width of the tape T. More specifically, the limit line 405a on the front side in FIGS. 14A and 14B indicates the limit of the position of the front side end of the tape T. If the front side end of the tape T is located at the rear of the front limit line 405a, Braille characters cannot be embossed at correct positions within the width of the tape T. On the other hand, the rear limit line 405b in FIGS. 14A and 14B indicates the limit of the rear side end of the tape T. Referring to the pair of limit lines 405 and the embossing position indication line 402 makes it possible for a user to determine the correct position at which to manually place the tape T.

A label can be produced by using the label producing apparatus 1 according to this invention in a manner similar to the first embodiment, by setting various items through menus. However, in the label producing apparatus 1 according to this embodiment, the position in the direction across the width of the tape at which to emboss Braille characters (the position of the Braille embossing area in the direction across the with of the tape) is determined by the position at which the tape T is manually placed on the Braille embossing apparatus 12, the Braille character layout setting menu does not include items associated with the position in the direction across the tape with. More specifically, the layout menu does not include a menu item corresponding to the “form” in the first embodiment, and the layout position of the ink-printed character string (the ink-printing area) and the position of the Braille character string (the Braille embossing area) is set through menus provided separately. As in the first embodiment, the layout position of the ink-printed character string can be set in both direction along the tape feed direction and direction across the tape width. However, the layout position of the Braille character string is allowed only in the direction along the tape feed direction. That is, only “left justification”, “center justification”, “right justification”, and similar formats are allowed.

After the setting of respective items is completed, if the print key is pressed, the ink-printing is performed on the tape T being fed from the tape cartridge C. After the ink-printing is completed, the tape T is cut off at a particular point to obtain a tape strip (hereinafter, the tape strip will also be referred to as the tape T unless confusion occurs). A user places the resultant tape T so that the position in the tape width direction at which to form the Braille character string on the tape T becomes coincident with the embossing position indication line 402, and the user slides the guide part 404 until the guide part 404 comes into contact with one of side end of the tape T. The user then manually transport the tape T in the downstream direction with the one side end of the tape T being guided by the guide surface 404a of the guide part 404 until the tape T reaches the tape feeding mechanism 82. Thereafter, if the embossing key is pressed, embossing on the tape T is performed, and thus a label on which the Braille character string is embossed at the position specified by the user is obtained.

In the label producing apparatus 1 according to the third embodiment, as described above, the position in the tape width direction at which to form Braille character string can be adjusted by manually adjusting the position of the tape T with respect to the embossing unit 81, and thus the mean for moving the embossing unit with respect to the tape T fixed at the position in the tape width direction is unnecessary. Therefore, it is possible to simplify the structure of the Braille embossing apparatus.

1. A sheet processing apparatus comprising:
embossing means for embossing a Braille character on a sheet according to inputted information while feeding the sheet;
Braille embossing area setting means for arbitrarily setting a position of a Braille embossing area in which to emboss the Braille character on the sheet; and
control means for controlling the embossing means in accordance with a result of the setting made by the Braille embossing area setting means.

2. The apparatus according to claim 1, wherein the Braille embossing area setting means sets the position of the Braille embossing area by selecting an arbitrary one of predefined options in terms of the relative position of the Braille embossing area on the sheet.

3. The apparatus according to claim 2, wherein the predefined options comprise left justification in which the leading end of the Braille embossing area is aligned with the leading end of the sheet in a direction in which the sheet is fed, center justification in which the center of the Braille embossing area is aligned with the center of the sheet in the direction in which the sheet is fed, and right justification in which the trailing end of the Braille embossing area is aligned with the trailing end of the sheet in the direction in which the sheet is fed.

4. The apparatus according to claim 2, wherein the predefined options comprise one positioning in which the Braille is embossed in substantially widthwise one half of the sheet and another positioning in which the Braille is embossed in substantially the other widthwise half of the sheet.

5. The apparatus according to claim 1, further comprising:
ink-printing means for ink-printing the character on the sheet in accordance with the inputted information while feeding the sheet; and
ink-printing area setting means for arbitrarily setting the position of an ink-printing area in which to ink-print the character on the sheet, wherein
the control means controls the ink-printing means in accordance with a result of the setting made by the ink-printing area setting means.
